(19) United States
(12) Patent Application Publication
(10) Pub. No.: US 2013/0280641 A1
(43) Pub. Date: Oct. 24, 2013

(54) METHOD FOR CREATING MULTILAYER HIGH ADSORPTIVE COVERING FOR FLUOROPOLYMERS

(71) Applicant: Jüri Liiy, Kuusalu (EE)

(72) Inventor: Jüri Liiv, Kuusalu (EE)

(73) Assignee: Visitret Displays Ltd., Tallinn (EE)

(21) Appl. No.: 13/497,093

(22) PCT Filed: Feb. 5, 2010
(86) PCT No.: PCT/EP2010/051454

§ 371 Date: Dec. 3, 2012

Related U.S. Application Data
(60) Provisional application No. 61/256,766, filed on Oct. 30, 2009.

(30) Foreign Application Priority Data
Feb. 5, 2009 (EE) U200900010

(51) Int. Cl. C08J 7/16

(52) U.S. Cl. CPC C08J 7/16
USPC 429/492; 428/421; 428/333; 427/412.1

(57) ABSTRACT

The present invention relates to a method for coating fluoropolymers with a coating substance, by atom transfer radical polymerisation and subsequent processing whereas a fluoropolymer is contacted with a reaction mixture comprising at least one ligand selected from the group consisting of multichained and polycyclic amines, at least one metal salt wherein the metal is in a first oxidation state, at least one solvent, and the organic coating substance in monomer form.

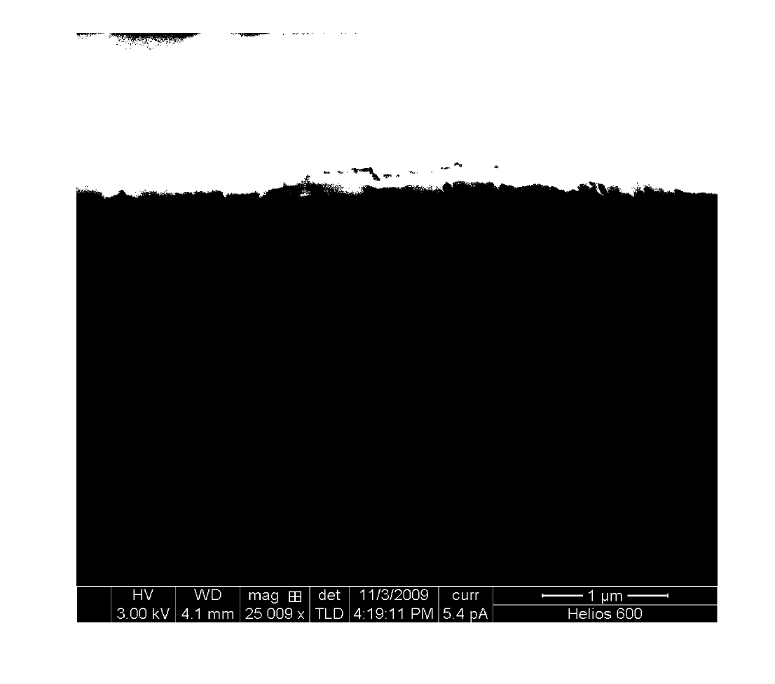

### TECHNICAL FIELD

The present invention relates to a method for coating fluoropolymers with a coating substance, by atom transfer radical polymerisation and subsequent processing.

### BACKGROUND ART

It is known that fluoropolymers (FP) have a very good resistance to chemicals and therefore are used in the manufacture of products which are exposed to aggressive chemicals. On the other hand the fluoropolymers also have a number of undesirable characteristic which in many cases conflict with their application, or make it difficult or impossible to manufacture. For example, the ability to adhere to plastics or even to many metals is poor, so that adhesivizing agents must be used, which result in a certain improvement of adhesion. When adhesivizing agents are used, however, and especially when thin films are to be applied to a substrate, it is often found that the adhesivizing agent migrates into the FP and adversely affects its chemical resistance.

Fluoropolymers were discovered in 1938 by Dr R J. Plunkett who synthesized PTFE (polytetrafluoroethylene, Teflon®). Fluoropolymers were introduced to mass market shortly after the invention because of the following unique characteristics:
Non-stick
High melting temperature
Low friction
Extreme durability under different conditions (chemical, UV light, radiation etc)
Characteristics of some fluoropolymers are uncommon to plastics
Piezoelectricity, ferroelectricity, pyroelectricity
etc

However there are many problems of using fluoropolymers, for example it is very hard to
coat fluoropolymers with other materials,
to glue them to other surfaces and
to functionalize with any chemical reagents because of their hydrophobic properties.

Although fluoropolymers are widely used, their application areas are limited because the conventional fluoropolymer coating technologies do not enable to create strong enough bonds between the fluoropolymer and applied layer in a way that the characteristics of the fluoropolymer would remain unchanged.

There are known different methods for creating multilayer high adsorbive covering for fluoropolymers such as
a method where the base polymer is mixed with various resins wherein some characteristics (electric, durability etc) of the polymer will be damaged;
a method using mechanical, thermal or plasma processing of the surface, these methods having the disadvantages such as weak bonding; limited application possibilities; and
methods with chemical treatment of the surface are under development.

Most of the methods remove the fluorine atoms from the surface but this doesn't assure sufficient hydrophility.

The document U.S. Pat. No. 4,308,359 B (DYNAMIT NOBEL AG) 29 Dec. 1981 describes a graft polymer of polyvinylidene fluoride wherein the polyvinylidene fluoride has grafted thereon at least 0.5 percent by weight and up to 98 percent by weight of a polymer of an ethylenically unsaturated compound, prepared by contacting in the solid phase polyvinylidene fluoride with a monomer of an ethylenically unsaturated compound and diffusing said monomer and a radical forming catalyst into said polyvinylidene fluoride in such an amount that said polyvinylidene fluoride remains in the solid phase and thereafter maintaining said polyvinylidene fluoride in the solid phase under polymerization conditions for said ethylenically unsaturated compound and polymerizing said ethylenically unsaturated compound in the absence of water and/or solvent. It is stated in this document that known catalysts which are usable in radical polymerization, such as for example organic peroxides or azo compounds, can be used as catalysts in accordance with the process described. The peroxides include, for example, dilauroyl peroxide, benzoyl peroxide, or percarbonates, such as dicetyl percarbonate or diisopropyl percarbonate, or peresters such as tert-butylperoxybenzonate. An example of a catalytically active azo compound is azoisobutyric acid dinitrile.

Fluoropolymers are widely used because of their high chemical, physical and biological stability; and other special characteristics. At the same time the surface of fluoropolymers is extremely hydrophobic that impedes attachment of any additives to it. Traditionally the consistence of the fluoropolymer is changed for attaching additives to its content (a compound with a more hydrophilic substance is formed) that significantly worsens polymer characteristics; or the surface of fluoropolymer is modified (chemically; corona effect etc) that doesn't enable introducing necessary amounts of additive nor controlling the behavior of the additives.

### DISCLOSURE OF INVENTION

In accordance with the objects of this invention there is provided a method for creating multilayer high adsorbive covering for fluoropolymers thus providing a method for coating fluoropolymers with a coating substance, by atom transfer radical polymerisation, comprising contacting a fluoropolymer with a reaction mixture comprising at least one ligand, at least one solvent, at least one metal salt wherein the metal is in a first oxidation state, an initiator and the coating substance in monomer form.

The novel coating method developed by the authors of the present invention consists of following principle steps:
Special chemical modification of the fluoropolymer surface
Applying necessary layers
Applying necessary functional components

The novel method consists of three phases:

1) replacing some fluorine atoms of fluoropolymer with a short chain of hydrophilic monomer (e.g. styrene) using ATRP reaction (Atom Transfer Radical Polymerization);

2) covering the surface of point (1) with inorganic monolayer (e.g. SiO₂; Al₂O₃; TiO₂);

3) precipitation of amorphous adsorbent layer with necessary thickness to the surface (Al₂O₃, SiO₂, TiO₂ etc).

If necessary then it is possible to cover the surface with another monolayer for protection against external influences. Such method enables to retain characteristics of the initial fluoropolymer and to isolate it absolutely from the additives; also to ensure stable and permanent surface covering and to achieve necessary characteristics for the surface coating. The method can be applied in nanoelectronics for producing smart particles, in medicine for producing smart capsules, for producing thin energy sources etc.

The method provides this by using a known method, for example atom transfer radical polymerization (ATRP). Conduction of ATRP reaction requires parallel dissolving capability of the organic and inorganic substances of the environment. So far usually mixtures of different ionic and anionic solvents (e.g. anisole and dihydrofurane) have been used that are unstable, toxic, flammable and very sensitive to different additives (including oxygen in gas form).

The novel method can also conduct ATRP reaction using liquid salt or a eutectic solvent that reacts like liquid salt (e.g. choline chloride and glycerol) environment that is stable, non-toxic and insensitive to additives.

Advantages of the Novel Method

All known fluoropolymers can be functionalized based on the invention. There is no need for adding resins and other components to the pure base polymer. All the characteristics of the base polymer remain unchanged. There is no need for mechanical, thermal or plasma processing of the fluoropolymer surface before grafting. Various monomers can be used to form the functional layer. Thickness and structure of applied layer can be strictly controlled. The fluoropolymer and applied surface are bonded with extreme strength. ATRP reaction can be directly initialized from existing fluorine atoms in base polymer.

Chemical Modification of Fluoropolymer Surface

Using multi chained or polycyclic amines as ligands in a metal complex using specific reaction initiators or using polymer crystal structure defects for initiating the reaction. Predisposed solutions (mixtures) will be used for the surface modification. The solutions will be rolled on the fluorocarbon surfaces in certain sequence.

After achieving hydrophilic layer on the surface of fluoropolymer the layer will be processed, using hydrolysis and sol-gel method, for coating the layer with additional inorganic, microcrystallic or amorphous layer.

A typical method for coating fluoropolymers with a coating substance, according to the present invention, by atom transfer radical polymerisation, thus comprises contacting a fluoropolymer with a reaction mixture comprising
at least one ligand selected from the group consisting of multichained and polycyclic amines,
at least one metal salt wherein the metal is in a first oxidation state,
at least one solvent, and
the organic coating substance in monomer form.

By organic coating substance in monomer form it is meant an organic substance that is capable of forming polymer chains.

According to an embodiment of the invention, the reaction mixture further comprises an initiator. The initiator can be selected from the group consisting of halides of organic acids such as isobutylic acid bromide or other organic halides. According to another embodiment, the initiation of the reaction is induced by the polymer crystal structure defects, thus no initiator is needed.

Typically, the coating substance is selected from the group consisting of styrene, sulphonic acid, metacrylate, ethylene-imine or some other hydrophilic monomer and mixtures thereof. The thickness of the substance coating layer can be from 1 nm to 100 μm.

The reaction mixture can also comprise metal salts in more than one oxidation state, for example Cu⁺/Cu²⁺, Fe²⁺/Fe³⁺, etc. The metal salt can for example be selected from the group consisting of CuBr, CuCl and FeCl₂.

According to an embodiment of the invention, the ligand is selected from the group consisting of tris(2-aminoethyl)amine (TREN), tris[2-(dimethylamino)ethyl]amine (Me6TREN), 2,2′-Bipyridine (bpy), tetraazacyclotetradecane (CYCLAM) and mixtures thereof. Naturally any other suitable ligands can also be used.

The fluoropolymer coated by this method can be any fluoropolymer. Some examples are polyvinylene, polytetrafluoroethylene, polyvinylfluoride and mixtures thereof. The fluoropolymer can be in any suitable form, such as in blocks, films or particles. When a film is used, the thickness of the film can be from 1 μm to 1 mm.

According to an embodiment of the invention, the solvent is selected from the group consisting of organic solvents, liquid salts and eutectic solvents reacting like liquid salts. Some examples of suitable solvents are a mixture of tetrahydrofuran and acetonenitrile, choline chloride, glycerol and mixtures thereof.

The method according to the present invention can also comprise a further step of coating the substance-coated fluoropolymer with an inorganic layer. The inorganic layer can be a layer of Al₂O₃, SiO₂, or TiO₂, and the coating can be made by hydrolysis of a metallorganic compound, such as Al(CH₃)₃. The inorganic oxide layer can also be a monolayer having a thickness of one aluminium oxide molecule.

The method can yet further comprise a further step of coating the substance coated fluoropolymer or the monolayer and substance-coated fluoropolymer with a layer of microcrystallic or amorphous metallic oxide using hydrolysis or sol-gel process. The thickness of the microcrystallic metallic oxide layer can be from 0.1 nm to 100 μm.

The reaction solution used in the present method can further comprise at least one antioxidant such as ascorbic acid. The reaction solution may also comprise at least one liquid salt such as a mixture of choline chloride and glycerol.

Typically, the reaction time is from 1 second to 60 minutes, and the reaction temperature is 30 to 90° C.

The present invention also relates to a fluoropolymer coated with a coating substance obtainable by the process of the invention.

The present invention further relates to a fluoropolymer coated with a coating substance, where the chain of coating polymer is chemically bonded with the chain of base polymer according to schema (1)

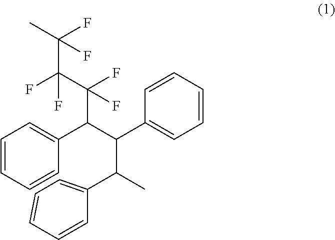 [SMILES: CC(c1ccccc1)C(c1ccccc1)C(c1ccccc1)C(F)(F)C(F)(F)C(C)(F)F]

Schema (1) shows a polyttetrafluoroethylene (PTFE) coated with a polystyrene layer.

In a coated fluoropolymer according to the present invention, the coating substance can be any hydrophilic polymer. Also, the thickness of the hydrophilic polymer coating is typically at least five styrene molecules. The fluoropolymer is can also be further functionalised.

The present invention also relates to uses of the coated fluoropolymer according to the present invention, such as for reaction column fillings, microfilters, electrical sensors, twist-ball or electrophoretic displays, membranes for biotechnology, fuel cell membranes or biodepositors.

The invention yet further relates to
a twist-ball or electrophoretic display comprising coated fluoropolymer particles obtainable by the present process,
membranes of fuel cells or hydrolysers that have been modified to become ion-conductive by the present process,
reaction column fillings where the catalysts will be attached by the present process,
functional microfilters that enable conduction of reactions or testing during filtration by the present process, and
micromachines and actuators where motive part (such as a nanovalve where the electrodes are attached to a polymer) is formed by the present process.

### EXPERIMENTAL PART

### Sample 1

Modification of PVDF microparticle based on the invention using different reaction conditions. Hydrophilic polymer (e.g. styrene) layers with different structures can be achieved based on the reaction conditions (catalyst, initiator and monomer concentration, temperature and time) that determine the quantity of reaction centres:
Amorphous
Blank
CellularAdvantages of the chemical modification method

As the bond created is very strong then fluoropolymers can be firmly attached to different materials to increase durability, decrease friction, and enhance appearances of these materials.

Such possibility enables to use fluoropolymers in new applications among market areas as: aerospace, military, chemical industry, shipping, automotive, construction etc where high durability is needed.

In the attached figure is illustrated the coated PVDF according to the method of the present invention where spherical particles of Solef 1008 PVDF were processed in solution of 15 mg of CuCl, 23 mg of TREN and 100 ml of pure styrene in 10 ml of mixture of dihydrofuran and anisole for 5 minutes keeping the temperature at 60° C. Cellular polystyrene layer with thickness 2 μm was achieved. After it the particles were processed in 10% solution of trimethyl aluminium for 5 seconds and thereafter the particles were coated with microcristallic alumina layer by thermal hydrolysis of acidated aluminium sulphate solution using temperature 75° C. during 20 min. Alumina coating with thickness 1 μm was achieved.

Applying Metal Layers

Chemical or ionic precipitation of different metals (Cu, Au, Pt, Al etc) is possible. Can be used for applying electrodes (including microelectrodes) or catalysts on fluoropolymer surfaces.

Application areas: Piezoelectrical micromachines, Piezoelectrical sensors, Functional membranes etc.

Applying Amorphous or Microcrystallic Anorganic Inert Layer

Application areas: Functional membranes, Catalyst fillings for columns, Fuel cell membranes (FP functionalized with catalyst and ion conductors), Microfilters (combining microfilters and functional testing materials), Depositor films and biodepositors, All-in-one tester films, etc.

### Sample 2

Applying amorphous or microcrystallic anorganic inert layer to the functionalised fluoropolymer. Alumina, silica, Ti0₂ and other oxides can be used. Steps of surface modification:
Replacing of F-atom with hydrophilic polymer chain
Cutting off the halogen atoms
Covering the surface with inorganic monolayer
Precipitation of thick microcrystalline inorganic layer

Sample 2 describes the possibilities to use the novel method for achieving adsorptive layer on the fluoropolymer surface.

The novel method enables to use fluoropolymers bonded to other materials in high value added applications where characteristics as extreme durability or low friction are needed; or preserving unique properties of pure fluoropolymers is necessary.

Application areas: fillings for columns; functional membranes, microfilters and films; chromatographic and other analysator films; fuel-cell membranes; biodepositors; smart fluoropolymer particles for different applications (including e-paper displays); etc.

1. A method for coating fluoropolymers with a coating substance, by atom transfer radical polymerisation, comprising contacting a fluoropolymer with a reaction mixture comprising
at least one ligand selected from the group consisting of multichained and polycyclic amines,
at least one metal salt wherein the metal is in a first oxidation state,
at least one solvent, and
the organic coating substance in monomer form.

2. A method according to claim 1 wherein the reaction mixture further comprises an initiator.

3. A method according to claim 1 wherein the initiation of a reaction using the reaction polymer is induced by the polymer crystal structure defects.

4. A method according to claim 1, wherein the coating substance is selected from a group consisting of styrene, sulphonic acid, metacrylate, ethylene-imine a hydrophilic monomer and mixtures thereof.

5. A method according to claim 1, wherein the reaction mixture comprises metal salts in more than one oxidation state.

6. A method according to claim 1, wherein the ligand is selected from a group consisting of tris(2-aminoethyl)amine (TREN), tris[2-(dimethylamino)ethyl]amine (Me6 TREN), 2,2′-bipyridine (bpy), tetraazacyclotetradecane (CYCLAM) and mixtures thereof.

7. A method according to claim 1, wherein the fluoropolymer is selected from a group consisting of polyvinylene, polytetrafluoroethylene, polyvinylfluoride and mixtures thereof.

8. A method according to claim 1, wherein the solvent is selected from a group consisting of organic solvents, liquid salts and eutectic solvents reacting like liquid salts.

9. A method according to claim 8, wherein the solvent is selected from a group consisting of mixture of tetrahydrofuran and acetonenitrile, choline chloride, glycerol and mixtures thereof.

10. A method according to claim 1, wherein the metal salt is selected from a group consisting of CuBr, CuCI and FeCI2.

11. A method according claim 1, wherein the initiator is selected from a group consisting of halides of organic acids such as isobutylic acid bromide or other organic halides.

12. A method according to claim 1, further comprising a further step of coating the substance-coated fluoropolymer with an inorganic layer of A1203, Si02, or Ti02 by hydrolysis of metallorganic compound.

13. (canceled)

14. A method according to claim 1, further comprising a further step of coating the substance coated fluoropolymer or the monolayer and substance-coated fluoropolymer with a layer of microcrystallic or amorphous metallic oxide using hydrolysis or sol-gel process.

15-18. (canceled)

19. A method according to claim 1, wherein the reaction mixture further comprises at least one antioxidant such as ascorbic acid.

20. A method according to claim 1, wherein the reaction mixture further comprises at least one liquid salt such as a mixture of choline chloride and glycerol.

21-22. (canceled)

23. A fluoropolymer coated with a coating substance obtainable by the method of claim 1.

24. A fluoropolymer coated with a coating substance, where the chain of coating polymer is chemically bonded with the chain of base polymer according to schema (1).

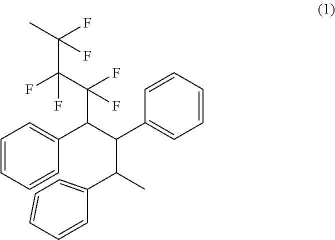 [SMILES: CC(c1ccccc1)C(c1ccccc1)C(c1ccccc1)C(F)(F)C(F)(F)C(C)(F)F]

25. A coated fluoropolymer according to claim 23, wherein the coating substance is any hydrophilic polymer and in that the thickness of the any hydrophilic polymer coating is at least five styrene molecules.

26. A coated fluoropolymer according to claim 23, wherein the fluoropolymer is further functionalised.

27. Use of a coated fluoropolymer according to claim 23 for reaction column fillings, microfilters, electrical sensors, twist-ball or electrophoretic displays, membranes for biotechnology, fuel cell membranes, or biodepositors.

28-32. (canceled)
